(19) United States
(12) Patent Application Publication
(10) Pub. No.: US 2007/0069920 A1
(43) Pub. Date: Mar. 29, 2007

(54) System and method for traffic related information display, traffic surveillance and control

(76) Inventors: A-Hamid Hakki, Dunedin, FL (US); Said Hakky, Largo, FL (US); Sam Hakki, Bay Pines, FL (US); Hadi Hakki, Largo, FL (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/232,917

(22) Filed: Sep. 23, 2005

(51) Int. Cl. G08G 1/095

(52) U.S. Cl. 340/907

(57) ABSTRACT

The system and method for traffic surveillance, control, and traffic related information display uses display units each having display element sensors and cameras where the operation is controlled by a processor. Anticipatory sensor systems continuously measure speed and deceleration of approaching vehicles, sends signals to the processor which in turn analyzes the incoming signals. A rapid sequence camera continuously records audio-video images. When the rate of deceleration exceeds a predetermined threshold, which may be indicative of an imminent accident, the processor activates a store regime of the audio visual images on-site or transmitted to an off-site location for further actions. The information on the traffic flow condition which may affect the vehicle travel is displayed on the display unit. The system provides for the detection of pedestrians about to cross an intersection and controls the traffic light pattern accordingly. The display unit utilizes shapes, motions, and color to provide for easily understandable messages to vehicle occupants and pedestrians.

### FIELD OF THE INVENTION

The present invention relates to a display system designed to demonstrate simple, reliable, clear, and universally understandable visual messages, for vehicles' occupants and pedestrians to aid in optimizing the efficiency of traffic flow as well as to increase safety considerations of people on the roadways.

It is another object of the present invention to provide a traffic control system measuring and analyzing traffic related data, and displaying the data in clearly understandable forms to provide vehicle occupants, as well as pedestrians, with information regarding speed of vehicles, traffic jams, or car accidents at a given portion of the road.

The present invention additionally relates to a traffic control system which predicts an eminent accident by calculating the rate of deceleration of vehicles approaching the intersection. This system includes devices continuously measuring speed and deceleration of approaching vehicles, as well as rapid sequence cameras for recording audio and video images of the vehicles at a predetermined intersection. When the deceleration rate exceeds a predetermined threshold, the processor unit directs the rapid sequence cameras to save audio visual images in their memory or in some other storage unit for further analysis.

The present invention further relates to a traffic control system which designates a specific coordinate to each intersection and transmits the speed of traffic at the particular intersection to nearby displays positioned in the vicinity of the intersection in question to inform drivers regarding the traffic parameters along the way of their travel.

The present invention also relates to a traffic control system which is adapted to detect the presence of people who are about to cross an intersection and to control the light sequence of the traffic lights accordingly.

### BACKGROUND OF THE INVENTION

Conventional traffic light fixtures have three compartments with each compartment receiving a light source of a specific color and usually require special fixation cables and supporting structures to provide stability and resistance to wind which is needed due to the longitudinal contour design of traffic lights. The three compartments design is not economic since it utilizes substantial quantities of metal and three light elements with relatively short life spans.

On streets with low vehicle clearances, existing traffic lights may be positioned horizontally which may cause confusion particularly for people who are colorblind or not accustomed to the horizontal configuration. In order to overcome the shortcomings of the existing traffic lights and to provide an economically safe display system a new design of traffic light is needed. There have been some efforts which have been undertaken to improve the design of existing traffic light devices.

For example, an engineer's manual (DTM10-8 Digital Traffic Micro Computer) was published on Oct. 20, 1997 authored by Namir Al-Dawoody, presenting an economical traffic light with a solitary compartment containing multicolor light emitting diodes. The single light source thus can produce variable colors contoured in different shapes which vary in accordance with the particular color displayed. Displayed messages many include indication of time or duration till the change in color and direction of traffic.

A working computerized version of an improved traffic light design was presented to the Motor Vehicle Administration in Washington, D.C. based on the concept that a solitary but larger housing may provide for added safety, stability and economy. Red, yellow and green colors are generated by the same light emitting elements in a customary sequence established by the traffic regulations.

In the past three decades, there have been a number of Patents designated as improvements in traffic light design. For example, U.S. Pat. No. 3,983,532 pioneered the concept of a single display traffic light structure and proposed the replacement of conventional incandescent lamps and color filters with one cathode ray tube and associated circuitry connected to emit the desired traffic control signal colors. The cathode ray tube displays characteristic traffic information indicators such as S for stop, G for green, and C for caution along with the background color signal as well as directional control arrows.

U.S. Pat. No. 4,839,647 teaches the use of unique geometric shapes that correspond to the three standard colors (red, yellow, and green), such as circular, diamond, and triangular shapes to make color information easily readable and distinguishable particularly for color-blind persons (who comprise 8% of all drivers) and those with impaired vision.

U.S. Pat. No. 4,857,920 proposes the use of a solitary light-emitting display having two or more semiconductor thin-film electroluminescent plates of red and green colors stacked on each other. A green circle denotes a “safe to go” condition, a red “X” signal indicates a dangerous condition and arrows are used for direction.

U.S. Pat. No. 5,136,287 describes a traffic-related message display comprising a non-reflecting panel that supports numerous high-intensity light emitting diodes arranged in different shapes, characters, symbols, words, or a solid color field for both pedestrians and vehicles. This design minimizes phantom images that may occur on the signal display when subjected to direct sunlight and have an extended life expectancy due to high life span of LEDs.

U.S. Pat. No. 5,519,390 is directed to a traffic light timer. A numeric message is displayed as a count down in seconds left until the color changes. The display may utilize light-emitting diodes, liquid crystal display, cathode ray tube, or a gas plasma display.

U.S. Pat. No. 6,072,407 presents a traffic light display which utilizes light-emitting diodes to display lights, symbols, or other messages. This system includes a main signal display area for conventional signal messages and at least one sub-signal display area for time left until the color changes. The time remaining for the color change is depicted as a full bar that gradually decreases in height until color change. The green bar is placed on the right side, and a red bar is placed at the left of the signal lamp to facilitate color recognition for color-blind people. Arrows pointing down indicate the flow of traffic. Similar but weaker signals are used for pedestrians.

A display shown in U.S. Pat. No. 6,175,313 uses a specialized housing with a rotating drum that is divided into three sections by non-transparent partitions each containing an individual lamp. The device is used as an attachment to conventional traffic lights.

A traffic surveillance system presented in U.S. Pat. No. 6,466,260 employs at least one traffic signal light, a television camera and a television monitor to display video signals, and sensors for detecting abnormalities at intersections. The surveillance system uses a temporary memory unit which saves images for 10 seconds or more and an acoustic detector that detects abnormal sounds. Since the audio-visual files are recorded on a video tape only when an abnormality is detected, the process minimizes tape consumption and reproduction time used. The image is super-imposed with the traffic light color in order to detect violators of the light signal. However, abnormal sounds may not always be due to accidents and many accidents particularly involving pedestrians may not cause audio signals of sufficient volume to be detected.

U.S. Pat. No. 6,111,523 describes a device including two sensors for triggering a camera to photograph a vehicle within a traffic intersection. A vehicle passing over a first sensor transmits a signal indicative of a vehicle speed, while a second set of signals indicates the presence of a vehicle.

Anticipatory sensors have been used to predict an imminent accident. As described in U.S. Pat. No. 6,749,218, the severity of an accident can be predicted using a pattern recognition technique including data storage media incorporating a pattern recognition algorithm or modular neural network. The information of an imminent accident is used in a variety of ways to minimize injuries such as by deploying external airbags. The speed of an approaching vehicle and angle of collision may be determined by means of using a variety of sensors, such as radar, lasers, ultrasound, electromagnetic wave systems, and passive infrared electromagnetic waves radiated from a vehicle to characterize its structure.

Prior art pre-collision systems for vehicles such as the Millimeter Wave Radar Sensor used by Lexus vehicles, assess the relative speed on an oncoming vehicle. The distance control Electronic Control Unit (ECU) determines whether the conditions are met for the operation of the pre-collision system. Once activated, the pre-collision system triggers collision dampening components in order to minimize damage caused by a collision. The Millimeter Wave Radar Sensor uses high frequency band between 30 GHz and 300 GHz, with short wavelength between 1 and 10 millimeters in a vacuum. The pre-collision system is not active if the speed of the oncoming vehicle is below a predetermined threshold, or if the objects cannot be detected by the millimeter wave radar, or are outside its range.

Although the art of traffic control and display systems has been thoroughly studied, as evidenced by the presented supra references, further developments are needed to improve the safety on the roads for both vehicles' occupants and the pedestrians.

It is clear therefore that although efforts have been made to improve the existing traffic control and surveillance, as well as the traffic light displays, none of the prior art systems use deceleration of vehicles to predict accidents, nor do they use rapid frame cameras to film events surrounding the potential accident.

### SUMMARY OF THE INVENTION

It is therefore an object of the present invention to provide a system for traffic surveillance, control, and display of traffic conditions as well as other suitable parametric information for vehicle's occupants and pedestrians. Such provides simple, reliable, clear and easily understandable visual messages, which enjoy low energy requirements, long operational life, and low maintenance profiles.

It is also an object of the present invention to provide a processor-based efficient traffic surveillance, control, and traffic information display system which permits prediction of a probable accident based on deceleration of vehicles and which displays the traffic condition on predefined portions of the road which may influence the intended trajectory of travel of vehicles and pedestrians.

It is a still further object of the present invention to provide a traffic information display system which enhances regulation of traffic in an efficient manner by providing the information regarding speed of vehicles, traffic jams, delays, etc. at a given intersection to other traffic displays at roads connected to the given intersection or which may be influenced by the traffic condition thereat.

It is also an object of the present invention to provide a traffic information display system which enhances regulation of traffic in a safe manner by detecting vehicles that have not cleared the intersection during change of color to red by causing a delay in change of color to green for the vehicles on the road who are about to enter the intersection. This violation may be recoded and transmitted to proper authorities. If a vehicle did not clear the intersection and a predetermined time has elapsed after the change to red color, a serious violation or an accident has occurred.

It is a further object of the present invention to provide a system for predicting an imminent accident by calculating the rates of deceleration of vehicles approaching the display and activating a rapid sequence filming of an imminent accident once the deceleration rate exceeds a predetermined threshold. Once the predetermined threshold is exceeded, audio visual information is stored in a memory block, and/or information is transmitted to traffic control authorities and possibly police authorities.

It is another object of the present invention to provide a traffic information display system that comprises a housing of an oval shape which contains therein sensor(s), camera(s), as well as light display, and which generates a variety of indicia by means of which useful information for vehicle's occupants as well as pedestrians is displayed. Such a traffic display also may have a traffic light duration indicator that uses easily understood rotating indicia along the circular rim surrounding the display.

It is also the object of the present invention to provide a traffic display which indicates the “STOP”, “GO”, or “WAIT” conditions in an easily understandable manner for people, including, but not limited to, color blind individuals.

It is still an object of the present invention to provide a traffic surveillance, control, and traffic information display system which uses Global Positioning System (GPS) to identify the location of vehicles as well as location of probable accidents as they occur.

It is a further object of the present invention to provide a traffic control and traffic information display system which permits detection of pedestrians who are about to cross a road at a predetermined intersection, and which triggers the walk signal as a function of the number of waiting pedestrians and/or the time pedestrians are waiting at the intersection exceeds a predetermined threshold.

It is a further object of the present invention to provide a traffic control and traffic information display system which permits continuous reprogramming of the duration of the time for green light for pedestrian crossing in an intersection based on the data acquired in the central processing unit as to the number of pedestrians, the time it takes pedestrian to cross as well as the time of day.

It is still an object of the present invention to provide a traffic control and traffic information display system which permits detection of pedestrians who have not yet cleared the crossroad at a predetermined intersection, and which will cause a delay in the change of red signal of traffic flow for a few seconds or until the pedestrian is on the sidewalk in order to minimize pedestrian accidents. This pedestrian violation may be recoded and transmitted to proper authorities.

The present invention represents a system for a traffic related information display as well as traffic surveillance and control. The system includes a plurality of display units positioned at predetermined locations along the trajectory of the traffic flow. The position of each display unit has a specific coordinate designated by the Global Positioning System (GPS). Each display unit includes a plurality of sensors continuously monitoring traffic flow by measuring vehicles' speed, acceleration, deceleration, etc. The display unit also includes a plurality of cameras (image sensing devices) which continuously record audio visual rapid sequence images of the traffic flow.

The system of the present invention is a processor-based system which includes a processor unit (Central Processor Unit) connected to all display units, which receives there from information measured and recorded, processes the received information, analyzes it, and upon analyzing the received information, controls the state of each display unit (such as “GO”, “STOP”, or “WAIT” status), issues signals corresponding to specific messages to be displayed thereon, generates a signal indicative of a probable accident, analyzes flow conditions in front of a specific display unit and on the road surrounding such a display unit, and triggers the “saving regime” of the recorded audio visual rapid sequence images of the traffic flow once an accident condition has been detected.

The processor unit includes a system for predicting accidents which is based on the algorithm calculating the deceleration rate of the traffic flow and issuing an accident alert signal once the deceleration rate of the traffic flow exceeds a predetermined deceleration level. When an accident condition is determined, the display units which may be affected by the accident display the accident relevant information in order that the vehicle's occupants as well as pedestrians are informed about the situation. The information related to the accident, including the deceleration rate, coordinates of the intersection or the portion of the road where the accident occurred, audio visual images recorded prior, during, and after the accident, as well as the state of the related display units is saved in a memory unit and is transmitted to specified predetermined authorities such as for instance police department, highway patrol authorities, or other predetermined sites. All cameras at the index intersection are activated simultaneously to gather as much information as possible regarding the accident.

The processor unit of the system of the present invention further includes a system for informing vehicle occupants of traffic conditions ahead of their current position along the trajectory of their travel. This system is based on an algorithm which processes the measured speed of the traffic flow at different locations, calculates the average speed of the traffic flow based on the GPS assigned coordinates of the portions of the road, and displays the information on the traffic flow condition at the display units in order that the vehicle occupants can be made aware of the speed of the traffic in front of them as well as other traffic flow information. The information of traffic conditions may be presented at the traffic display either as a speed (miles per hour), or time to travel a specific distance, (minute per mile or second per mile), preferably in particular increments, or as a deviation in miles per hour, from the normal traffic flow parameters for the specific locations, time of the year, and/or time of the day.

The system of the present invention further permits detection of pedestrians waiting at an intersection. The processor receives the information on the number of waiting pedestrians or the waiting time of pedestrian(s) at the intersection, and issues a signal for switching the state of the display unit to permit the pedestrians to cross the road once the number of detected pedestrians exceeds a predetermined threshold number, or the waiting time exceeds a predetermined time threshold for a particular intersection, or a combination of both.

The system of the present invention also includes a plurality of portable traffic displays capable of performing the same function as stationary display units mounted at specific locations in the roadway. These portable traffic displays are operationally coupled to the processor unit for transmitting information thereto and receiving control signals there from. However, portable traffic displays can be easily moved from one location to another and do not need stationary installation hardware.

Each of the display units includes an oval shaped housing with a single compartment containing a plurality of sensors such as radars, lasers, a plurality of cameras for recording audio-visual images of the traffic flow, a plurality of light emitting elements such as for example LEDs (light emitting diodes) or lasers, and a color display area for displaying red, green, or yellow colors as indications of the “STOP”, “GO” and “WAIT” states of the display units. Displays of different messages may include time of the day, weather conditions, different parameters of the traffic flow in the areas which may affect the traffic flow, etc.

Each display unit includes a time indicator which is formed as an annularly contoured element surrounding the colored display area with indicia traveling there along. Depending on the time period remaining until the switch of the state of the display unit, the indicia travels along the time indicator ring either clockwise or counter-clockwise. If the time remaining until the switch of the display unit color is below 60 seconds, the time indicator indicia will travel clockwise. However, if the time remaining exceeds 60 seconds, the indicia will move along the time indicator in a counter-clockwise direction.

A unique oval design of the housing of the display unit permits easy indication of the direction of the traffic. When it is positioned horizontally, it indicates a right and left direction. When the housing is positioned vertically, it indicates the forward direction of the traffic. When the housing is slanted at an angle from the vertical, it indicates the direction of the traffic.

The green signal identifying the “GO” state of the display unit is presented in the form of a revolving green tire. This facilitates the differentiation of the “GO” state from the static red signal of the “STOP” state which is particularly useful for color blind people or those with impaired vision.

In the implementation of the rotating time indicator, the rim of the light element surrounding the color display area permits a space saving function in the single compartment housing and enhances the comprehension of the message being delivered. The rim of light elements is of the same color as the signal displayed in the color display area but may be given a different shade of the color.

It is an important feature of the system of the present invention to provide prediction information of a probable accident by the detection of excessive rates of deceleration and the direction of the approaching vehicle using sensors such as for example, radar. The processing unit triggers the saving and storage of images that are being continuously filmed by the rapid sequence scanners for the short period of time surrounding the accident. Documentation of events surrounding an accident by audio and visual recordings is made available for later retrieval and analysis. The cameras also record the color of traffic light as reflected by reflectors positioned in the inside of the hood or visor of the housing of the traffic light display. The color of the traffic light is superimposed on the final image thus providing an improved representation of events surrounding the accident.

Cooperation with the Global Positioning System (GPS) to identify the location of probable accidents as they occur, and transmission of the relevant information to nearby traffic displays and to traffic control authorities, provides for more efficient traffic surveillance and control. This permits rapid response measures to be undertaken by traffic authorities subsequent to the accident.

The present invention is further directed to a method for traffic surveillance, control and traffic related information display which includes the steps of:

positioning a plurality of electronic display units along traffic flow trajectory and connecting the display units to a processor (central processing unit) for processing the information regarding the traffic flow;

continuously measuring parameters of the traffic flow approaching a predetermined location by a plurality of sensors of the display units;

continuously recording audio-visual rapid sequence images of the traffic flow by a plurality of image sensing devices (cameras) of the display units;

sending the information from the display units to the processor unit and calculating deceleration rate of the vehicles approaching the predetermined display unit;

comparing the measured deceleration rate of the approaching traffic flow with a predetermined level; and

triggering the processor unit to save the audio visual images in a memory block once the deceleration rate exceeds the predetermined deceleration level.

The method further includes the step of:

issuing a signal corresponding to the detected probable accident to be displayed on the display units at locations at which the traffic may be influenced by such an accident.

In the method, a plurality of sensors in the display units measure the speed of the traffic flow and the processor unit calculates the average traffic flow speed at certain portions of the road based on GPS assigned coordinates of the display units. Once the measured speed of the traffic flow exceeds a predetermined threshold, the processor unit sends a signal to save the audio visual records. The information on the traffic flow is displayed on the display units which indicates to the vehicle's occupants as well as to the pedestrians the traffic condition in front of the traffic flow trajectory, in order that the vehicle occupants may make a decision whether to continue their current pathway or to switch to other roads. The information on the traffic flow conditions is presented either in the form of speed of the portions of the road ahead, e.g., miles per hour; or as the estimate of time of travel through a predetermined distance in specified increments (e.g. minutes per mile, minutes per half mile, seconds per mile, etc.).

The method further includes the steps of detecting pedestrians waiting to cross a road and of switching the state of the color display area to indicate the “GO” signal once the detected number of the waiting pedestrians exceeds a predetermined threshold number, or the waiting time of the detected pedestrians exceeds a predetermined time threshold, or a combination of the two.

The method of the present invention further includes the steps of displaying an information message on the display unit which may include color and specific indicia indicative of the “GO”, “STOP” or “WAIT” state of the display unit, speed limit, speed of the traffic flow at the portion of the roads connected to the display unit, accident alert, direction arrows, time of day, as well as other information.

These and other features and advantages of the present invention will be fully understood from the following description of the present invention accompanied by the Drawings.

### BRIEF DESCRIPTION OF THE DRAWINGS

FIG. 1 is a schematic representation of the system for traffic surveillance control and traffic related information display of the present invention;

FIG. 2 is a schematic view of the system of the present invention positioned at an intersection;

FIG. 3 is a front view of the display unit of the present invention displaying a stationary “STOP” signal, weather information, and a time indicator;

FIG. 4 is a front view of the display unit of the present invention showing a revolving green tire signifying the “GO” state and a time indicator showing that fifteen seconds remain to the change in the color;

FIG. 5 is a front view of the display unit of the present invention showing a yellow “WAIT” signal and a time indicator with fifteen seconds remaining until the change in color;

FIGS. 6A and 6B show a front view of the display unit of the present invention horizontally oriented with an arrow pointing to the left to indicate direction of traffic flow and left turn (FIG. 6A) and with the arrow pointing to the right to indicate direction of traffic flow and right turn (FIG. 6B);

FIG. 7A is a front view of the display unit of the present invention showing that a pedestrian is permitted to cross the road and with the time indicator showing fifteen seconds remaining until the change of the signal;

FIG. 7B is a front view of the display unit of the present invention showing the “STOP” signal for the pedestrian and a time indicator showing fifteen seconds remaining to the change of the signal;

FIG. 8 is a schematic representation of the system of the present invention with the display units positioned at intersections A, B, and C in which an average speed of vehicles approaching each intersection is calculated utilizing GPS coordinates for each intersection;

FIGS. 9A and 9B are a front view of the display unit of the present invention positioned at the intersection A indicating the speed of the traffic in front of the intersection A (FIG. 9A) or indicating that it will take one minute to travel one mile (FIG. 9B);

FIG. 10 is a flow chart diagram of the algorithm underlying operation of the system of the present invention for calculating and displaying the traffic flow condition in front of the vehicle as presented in FIGS. 8, 9A, and 9B;

FIGS. 11A and 11B are flow chart diagrams of two alternative algorithms of the sub-system for pedestrians crossing intersection;

FIG. 12 is a flow chart diagram of the algorithm of a sub-system for prediction of accidents of the present invention;

FIG. 13 is a flow chart diagram of the algorithms of the sub-system of the present invention for changing the regime of the display unit depending on the level of the ambient light; and,

FIG. 14 is a flow chart diagram of the algorithm underlying the operation of the sub-system of the present invention which takes place once a malfunction of the display unit is detected.

### DESCRIPTION OF THE PREFERRED EMBODIMENT

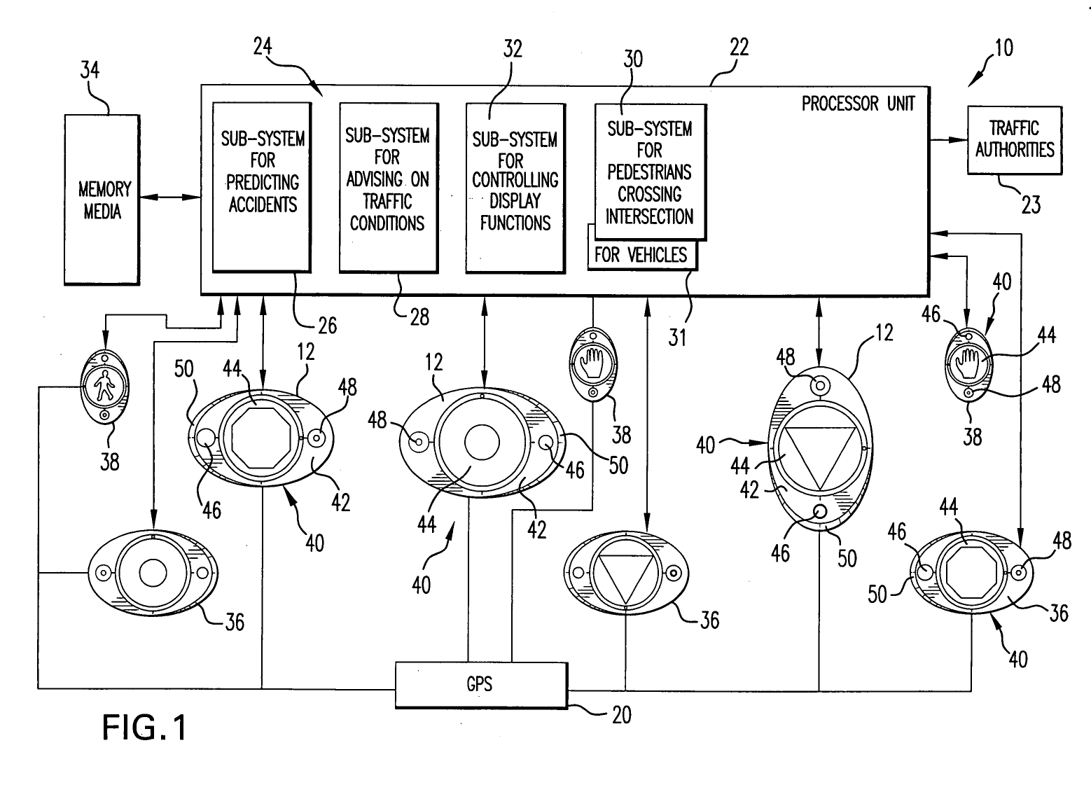

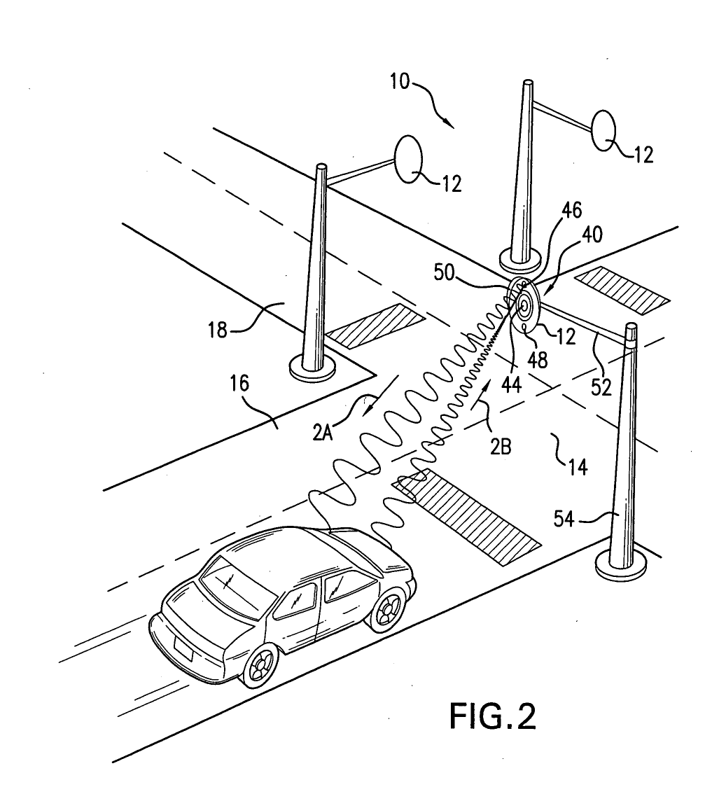

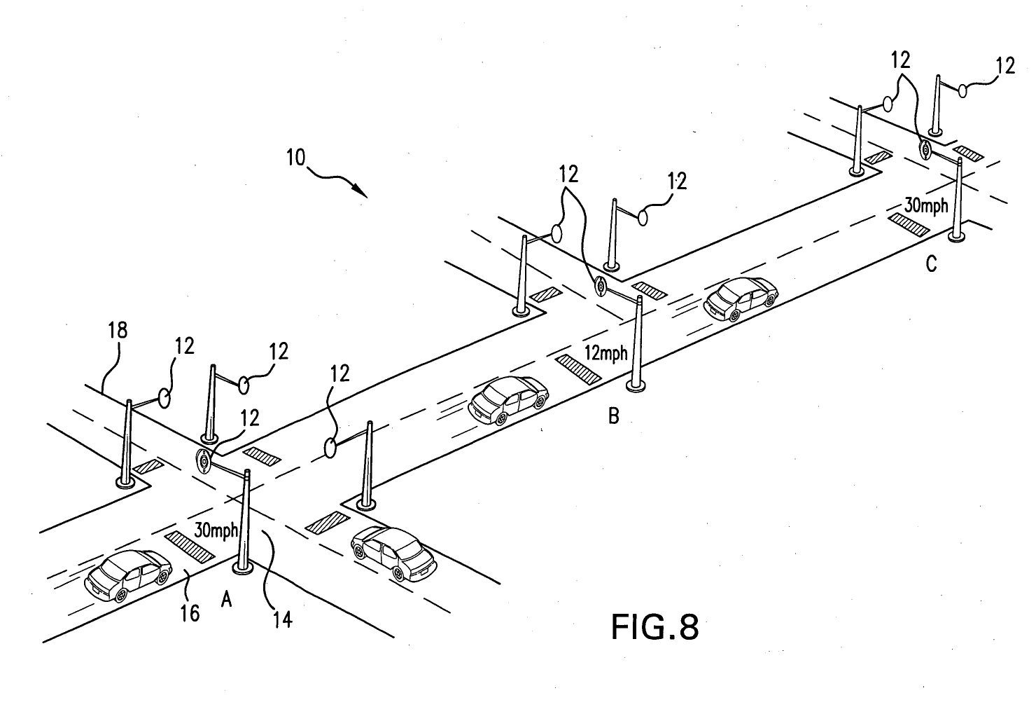

Referring to FIGS. 1, 2 and 8 a system 10 for traffic surveillance, control, and traffic related information display is shown which includes a plurality of display units 12 positioned at predetermined locations along the traffic flow. The system 10 of the present invention may also be called a Traffic Entry Display and Surveillance System, or TEDS system. The display units 12 may be located at intersections 14 as shown in FIGS. 2 and 8. It should be readily available for those skilled in the art that, although being shown as positioned at the intersection 14, the display units 12 of the present invention may be positioned at any location along the road 16, 18. The coordinate of each display unit 12 is assigned by a GPS (Global Positioning System) 20. Each display unit 12 is connected to a processor unit 22 (Central Processing Unit) which receives information from the display units 12, processes and analyzes the information, and issues signals transmitted to the display units 12 based on analyzed information. This permits controlling the state of display units 12, displaying specific messages thereon, as well as controlling functioning thereof and for transmitting traffic related information to traffic authorities 23, such as for example, police departments, highway patrol authorities, etc.

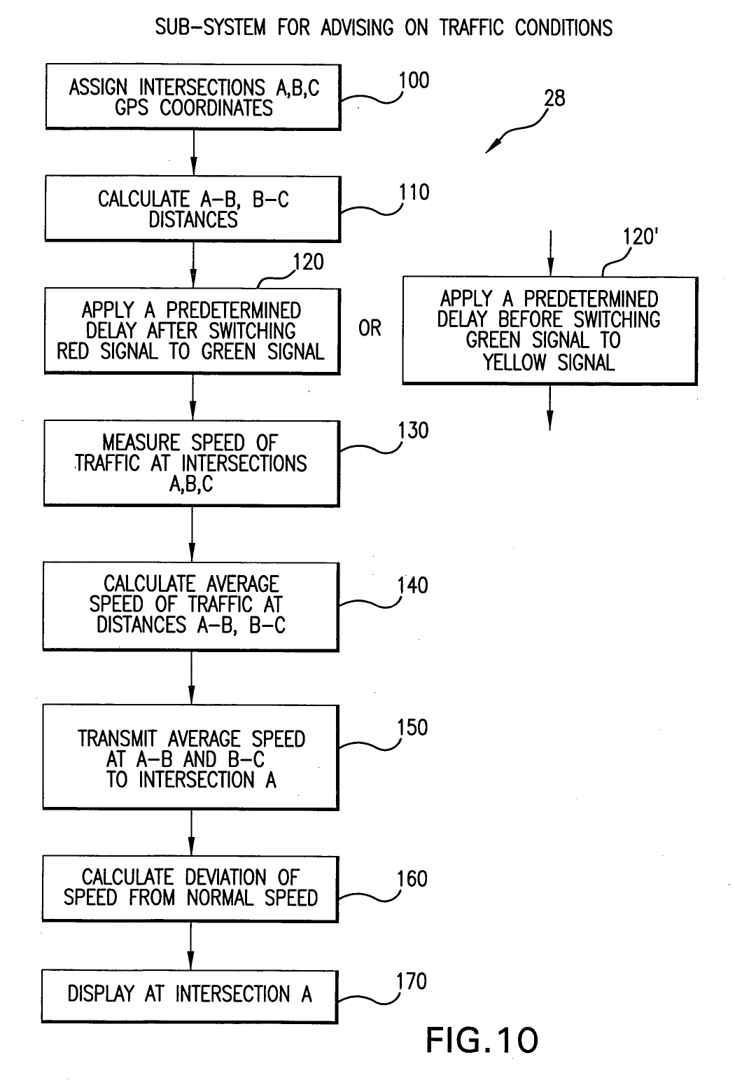

The processor unit 22 analyzes and processes data from the display units 12 based on an algorithm which has been developed for the specific purposes of the system of the present invention. The algorithm 24, best shown in FIGS. 10-14, of the present invention includes several sub-systems, such as a sub-system for predicting accidents 26, a sub-system 28 for advising on traffic conditions for informing vehicle occupants and pedestrians as to traffic conditions on the roads connected to the intersection in question. A sub-system 30 detects pedestrians waiting to cross the road, and switches the state of the display unit 12 accordingly. A sub-system 32 controls the functioning of the display units 12 which includes an algorithm for switching the regime of operation of the display unit depending on the level of the ambient light. An algorithm determines malfunctioning units as well as the sub-system for switching the state of the display unit, sub-system for sending specific messages to be displayed on the display units, sub-system for controlling the time indicator, etc., as will be presented further in following paragraphs.

The system 10 of the present invention further includes a memory block 34 for saving information related to probable accidents or other traffic related events and conditions for further analysis. The memory block 34 as envisioned is any storage unit having sufficient memory to store different parameters of the traffic flow, coordinates of events, audio-visual images, and any information pertaining to the traffic flow.

The system 10 of the present invention may further include a plurality of portable traffic displays 36 which can be movable and easily installable at any desired position along the traffic flow. The portable traffic displays 36 have the same functions and capabilities as display units 12 and are bi-directionally connected to the processor unit 22 to exchange signals there between and to be controlled thereby.

The intersection 14 is shown in FIGS. 2 and 8 where several display units 12 are installed for monitoring the traffic flow. As shown in FIGS. 1-7 and 9A-9B, each display unit 12 has a housing 40 contoured as an ovally-shaped compartment having a front wall 42. A color display area 44 is positioned on the wall 42 which permits the display of the state of the display unit 12 such as “GO” state, “STOP” state, and “WAIT” states. A plurality of light emitting devices, (not shown in the Drawings) is positioned within the housing 40.

The light emitting devices are controlled by the processor unit 22 to change the color as well as shape of the indicia shown in color display area 44. The light emitting devices may occupy any area of the front surface of the display unit 12 and also are used for displaying messages, changing information, as well as for indicating time remaining to the switching of the state of the display unit 12. These light emitting devices are commercially available and are known to those skilled in the art. The control scheme for the light emitting devices is readily understandable by those skilled in the art and therefore no detailed description is provided. The display unit 12 further includes a plurality of sensors 46, such as for example radar or lasers, for sensing approaching, passing vehicles and pedestrians. These sensors are also used for measuring speed and detecting the direction, etc., e.g. measuring the parameters related to the traffic flow.

The display unit 12 is also provided with image sensing devices such as cameras 48 which continuously record audio visual rapid sequence images of the traffic flow. The sensors 46, as well as cameras 48, may be positioned at any location at the housing 40 of the display unit 12.

The light display 12 is enclosed in the housing 40 which includes a rear enclosure and a display support structure (not shown in the Drawings). The housing 40 has an oval-shaped contour with a longitudinal dimension which is shorter than the length of a conventional traffic light and a width that generally is greater than that of conventional traffic lights. The housing 40 conveniently incorporates the sensors 46 and cameras 48 within a single compartment. The light emitting devices may be one or more of devices such as light emitting diodes, liquid crystal displays, cathode ray tubes, gas plasma displays, or other light sources.

The housing 40 has a hood, or visor, 50 provided to permit better visibility and to protect the front panel 42, which includes a color display area 44, sensors 46 and cameras 48 from the environmental solutions. One or more light reflectors are positioned on the inner surface of the hood 50. The light reflectors face the camera lens in order to continuously superimpose the color of the color display area 44 on the image of the road and vehicles recorded by the camera 48.

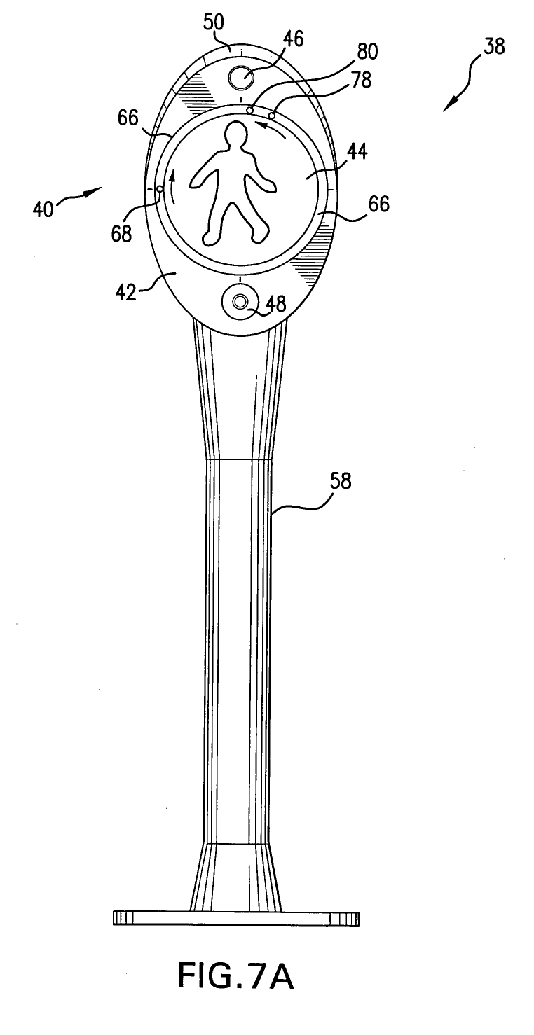

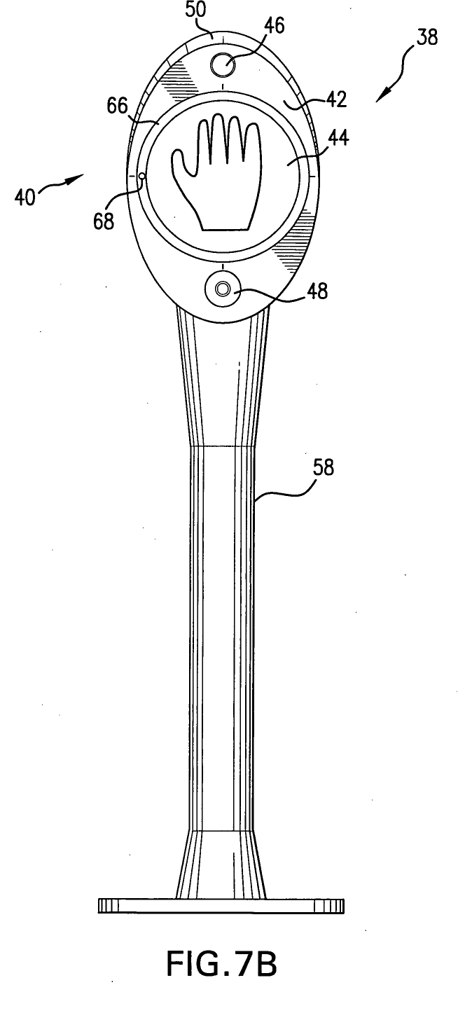

An access conduit for all wiring is secured to the rear enclosure (not shown) which communicates with the interior of the display housing 40. The display support structure is secured to the rear enclosure and is sealed to protect the display components from environmental damage. The entire structure of the display unit 12 is supported by beams 52 and poles 54, shown in FIG. 2, the size of which as well as the shape, being designed to securely support the weight of the display unit 12 and also take into consideration the force of wind which the display unit may be subjected to. Due to the use of a solitary compartment of the display unit 12 for housing sensors, cameras, as well as light sources, the overall weight, dimensions, and wind resistance of the display unit of the present invention provide an optimized profile when taken with respect to conventional traffic lights. For pedestrian displays 56, shown in FIGS. 7A and 7B, the supporting structures include a pole 58. The power source for powering the system 10 of the present invention may include any of a number of known sources such as, for example, electrical power sources, solar panels, wind turbines, etc.

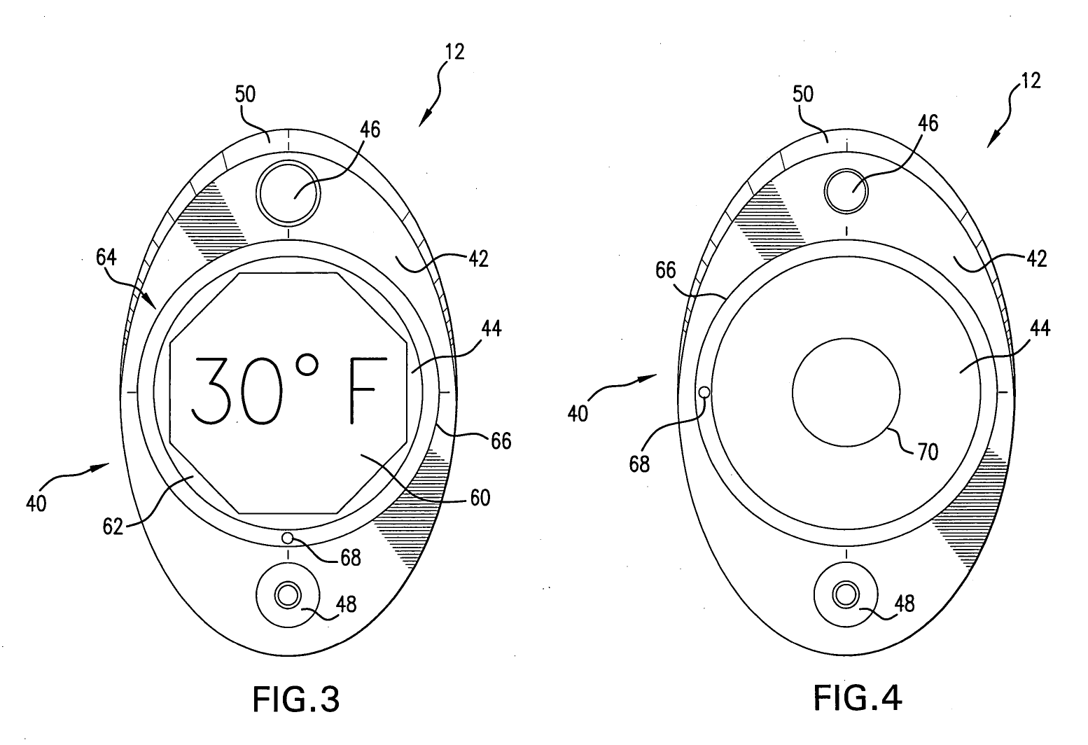

Referring to FIG. 3, showing the front panel 42 of the display unit 12 of the present invention, a “STOP” state of the operation of the display unit is presented. The “STOP” signal in the system of the present invention is indicated as an octagonal contoured FIG. 60 of red color presented in the color display area 44. In addition, the stationary red “STOP” signal can be presented in association with a background color area 62 which is colored in different shades of red thus indicating the phases of the day such as night, dawn, sunrise, noon, and sunset.

In order to enhance the safety for pedestrians and vehicle occupants on the roads, the display unit 12 of the present invention has a time indicator 64 which informs the pedestrians as well as vehicle occupants of the time remaining to the change of the color signal. The time indicator 64 is formed as an annularly-shaped ring 66 of the same color as the color within the color display area 44. Indicia 68 moves along the annularly shaped ring 66 either in a clockwise direction or in a counter-clockwise direction dependent on the time to the switching of the signal. For example, if the time to the change in color is thirty seconds, then indicia 68 starts at the 6:00 position and the color change occurs when the indicia 68 reaches 12:00 position. If the time remaining to the switch of the signal is below sixty seconds, then indicia 68 rotates clockwise along the ring 66. While if the time to the change of signal exceeds sixty seconds then the indicia 68 rotates along the ring 66 in the counter-clockwise direction.

The annularly shaped ring 66 may be of any shade of the color which is presented in the color display area 44. Indicia 68 can be presented in different manners, and can be presented as an arrow or arrowhead, a dot, a crescent, a star, etc. The shape and the number of indicia 68 may be utilized to denote the phase or time of the day. For example, a one-star indicia 68 may indicate sunset, two stars may indicate nightfall, three stars may be used to indicate dawn, four stars to signify sunrise, five stars to indicate noon, while six stars may be used to signify afternoon. As shown in FIG. 3, weather information such as a current temperature (30° F.) is shown on the red octagonally contoured FIG. 60 within the color display area 44.

Shown in FIG. 4 is a front panel 42 of the display unit 12 showing a green “GO” signal in the color display area 44. In the present invention, the green signal is presented as a revolving tire 70 of green color. The green “GO” signal is a dynamic signal in comparison with the red octagonal contoured FIG. 60. Signal 70 may be easily differentiated by color blind people or those with less than optimal vision particularly from a distance. The rotating motion of the green tire 70 is easily understood by all, pedestrians or/and vehicle occupants, to be the signal to “GO”. The speed limit for the traffic conditions may be briefly inscribed on the green display immediately upon the green color turning ON since longer inscription may be a source of distraction for people. The time indicator 64 similar to that presented in FIG. 3 surrounds the green revolving tire 70. However, for the “GO” situation, the annularly shaped ring 66 is of a light green color. The speed of the rotation of the green revolving tire 70 may be proportional to the speed limit on the particular lane or road, or to the safe speed for current traffic conditions, location, or weather conditions such as icy roads. The speed of rotation of the green tire 70 may vary depending on different factors, such as, for example, inclement weather, icy roads, and the like.

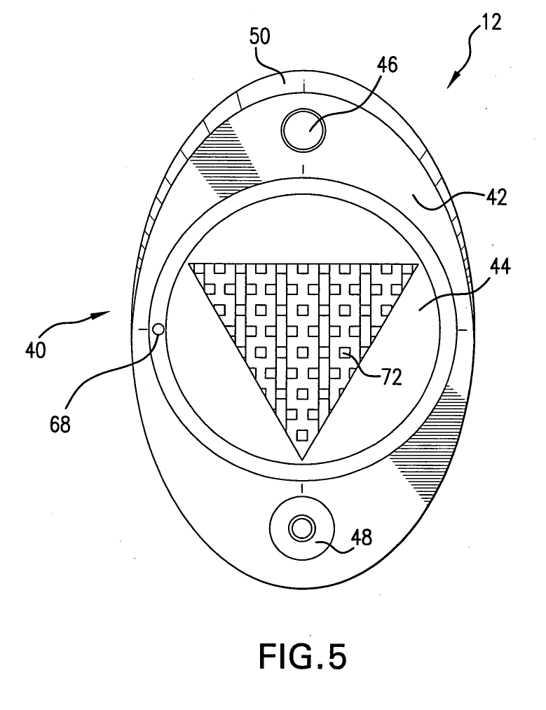

Shown in FIG. 5 is a display unit 12, the color display area 44 presents the yellow “WAIT” signal to indicate caution and to warn of the change in color to the red signal. The yellow “WAIT” signal is presented by the inverted triangularly-shaped yellow FIG. 72. The time indicator 64 similar to that shown in FIGS. 3 and 4, but in yellow, indicates the time remaining to the switch of the yellow signal to red.

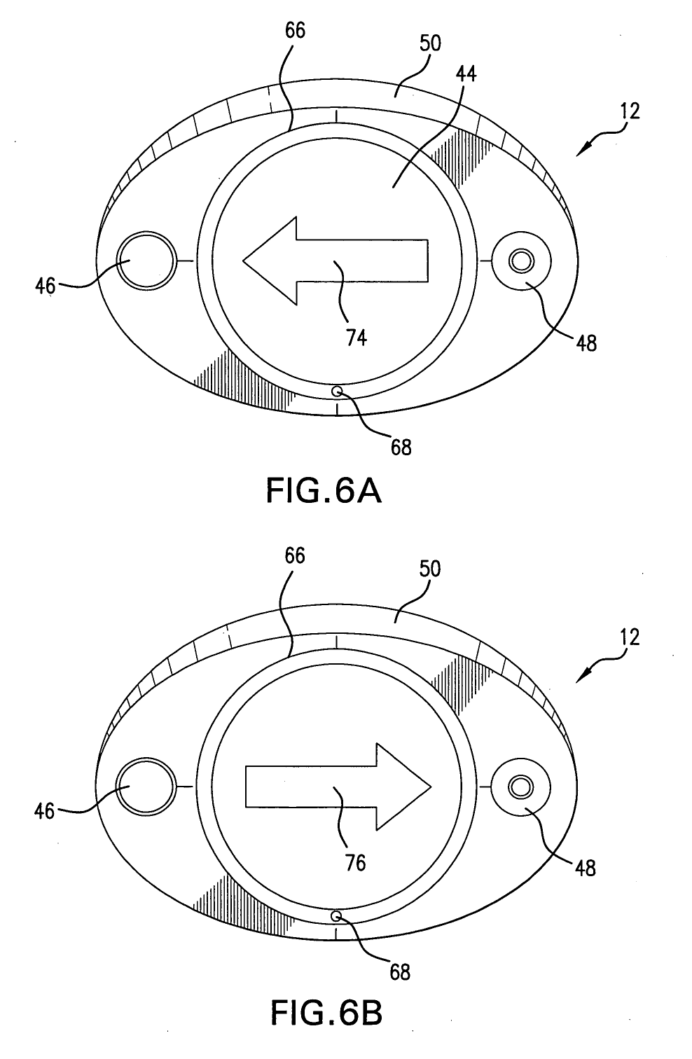

Referring to FIGS. 6A and 6B, a horizontally positioned display unit 12 is shown which has a left and right turn arrow 74 and 76 respectively. When the color turns green, the arrow 74, as in FIG. 6A, or 76 as in FIG. 6B, will appear in the color display area 44 on the front panel 42 to denote the signal “GO” in the allowed direction. The green “GO” arrow is presented as a moving arrow towards the direction of traffic flow. When the color display area 44 indicates yellow signal, the left or the right yellow arrow may flash; while if the color display area 44 displays a red signal, the arrows 74 and 76 in red are stationary. Existing turn signals may house a combination of five lights such as red, yellow and green signals in addition to one green and one yellow arrow. For such turn signals the current invention will provide the same sequence of signals with one compartment, namely, a green moving “GO” arrow, a flashing yellow arrow, a green rotating tire “GO” signal (left turn yielding to oncoming traffic), and a yellow and red signal. Depending on the traffic location, a red arrow may be added. In addition, two green moving arrows pointing to the roads ahead may be needed, or a green arrow superimposed on a revolving green tire.

For red, yellow, and green arrows 74 and 76 displayed in the color display area 44, the time indicator 68 will have the same color as the arrow and will show the time remaining in the switching of the signal to another.

FIGS. 7A and 7B represent a front view of the display unit 12 designed for the pedestrians. As shown in FIG. 7A, the front panel 42 of the display unit 12 for pedestrians displays a figure of the pedestrian walking in green, with a rotating time indicator 64 having an annularly shaped ring 66 of green. The rotating indicia 68 shows how much time remains until the signal switches from green to yellow. When the “STOP” signal for the pedestrians is to be displayed, the color display area 44 will show an open hand, shown in FIG. 7B in red surrounded by the annularly shaped time indicator 64 with the ring 66 of red and with indicia 68 showing the time remaining until the switch to the green signal occurs.

The rotating indicia 68 begins “ticking” approximately 60 seconds before the change of the signal. This makes it easier for pedestrians to discern how many seconds it will take them to cross the intersection. If the time to the walk signal shown in FIG. 7A, is more than 60 seconds, for example, five minutes, then the indicia 68 will be located at location 78 corresponding to five minutes on the clock. For every minute that passes, the indicia 68 will rotate counter-clockwise to the next segment on the annularly shaped ring 66 until it is one minute away from the topmost location corresponding to 12:00. At this time the indicia 68 begins rotating clockwise from the location 80 corresponding to one minute from 12:00 to the topmost location corresponding to 12:00.

The sensors 46 within the traffic display unit 12 detect pedestrians who are about to cross an intersection. These pedestrians are generally stationary compared to other pedestrians walking on the sidewalk and thus move in and out of the field of the sensors 46 and cameras 48. The subsystem 30 presented supra and discussed more in detail infra in the current Patent Application, permits the system 10 of the present invention to change the color of the signal for the pedestrians and to switch the red “STOP” signal to the green “GO” signal if a waiting time threshold or the number of pedestrians or a combination of the two is exceeded beyond a predetermined amount. An example of the combination program is a time threshold of 60 seconds for one pedestrian, 50 seconds for two pedestrians, 40 seconds for five pedestrians, etc. Alternatively, the time of day may influence the program for the time threshold, such as peak pedestrian hours, or the early morning hours.

The traffic control and traffic information display system 10 of the present invention permits continuous reprogramming of the duration of the time for green light for pedestrians crossing the road at an intersection based on the data acquired at the CPU 22 regarding the number of pedestrians, time it takes the pedestrians to cross the road, as well as the time of day. The system 10 also detects the pedestrians, which may include handicapped individuals, as well as elderly people, and others who have not cleared the crossroad at a predetermined intersection, and delays the change of the RED (“STOP”) signal to the GREEN (“GO”) signal for the traffic flow for a few seconds or until the pedestrian(s) finished the road crossing. Subsequently the light display 44 will signal the pedestrians to cross the street which is presented by the green human figure on FIG. 7A. By the same principle, the algorithm underlining the function of the processor unit 22, and the overall system 10, regulates the flow of vehicle approaching the intersection.

The subsystem 31 detects the vehicles standing at the intersection at the red light. If there is no vehicle crossing in a perpendicular direction, subsystem 31 compares the number of the vehicles about to cross the intersection or their waiting time with a predetermined number or time threshold. If such a threshold is exceeded then processor unit 22 switches the signal of the respective display unit 12 to the green “GO” signal, thus permitting the vehicle to pass through the intersection. Central processing unit 22 controls the situation at the intersection and assures that the signals provide for the safety of pedestrians and vehicles.

The system 10 enhances the regulation of the traffic in a safe manner by detecting the vehicles which have not cleared the intersection during the transition of the signal to the RED (“STOP”) signal and by delaying the transition of the traffic signal to the GREEN (“GO”) signal for the vehicles on the crossing road which are about to enter the intersection. If a vehicle did not clear the intersection during a predetermined time period after the change of the signal to the “STOP” signal, it may indicate a serious violation or an occurring accident. The relevant information will be then recorded and transferred to traffic authorities.

Referring once again to FIG. 2, the system of the present invention permits updating the speed of vehicles continuously on a road or lane. The traffic related information is transmitted to the display units located on roads connected or leading to the given intersection. For instance, if in front of a given intersection, there is a traffic jam and vehicles are moving at a low speed of 1.0 mph, the speed of traffic in that location is shown on the steady “STOP” red signal of the display units positioned at intersections close to the site of the traffic jam to permit drivers to seek alternative routes. Similar inscriptions may be shown on left, right and slanted turn signals for the speed on the roads in the respective direction.

The system of the present invention predicts accidents by measuring deceleration rate of the vehicles by means of using radar or other sensors. When a predetermined threshold is exceeded by the measured deceleration rate, the computer processing unit 22 triggers rapid sequence cameras 48 which continuously record audio/video images at the intersection. In this manner video and audio data is stored in the memory unit 34 immediately before, after, as well as during, the detected deceleration.

The sensors 46 include emitting and receiving sources for radar, laser, or other devices for speed and object recognition. The sensors 46 continuously monitor the traffic activity for each lane on the road. There will be one or more sensors 46 and one or more emitting sources that cover one or more vehicles. The areas of emission and sensing by different sensors may overlap. The speed, size, shape, and direction of each vehicle at any moment are assigned a coordinate location on the road by the GPS. Existing GPS technology permits the transmission of the location of the sensors 46 and cameras 48.

Infrared night vision and flash photography may be utilized when the level of ambient light is below a predetermined level. When there is mechanical or electrical failure, or when inclement weather interferes with proper sensor or camera function, indicia is displayed on the display unit 12 showing that the devices at this location are not functional. This malfunction is transmitted to the traffic authorities 23 by the processor unit 22. In another embodiment of the present invention, the system allows for the replacement of stop signals at intersections with traffic entry displays that streamline traffic flow more efficiently. It may also be used to measure the speed of vehicles and provide an audio/visual record of speed and deceleration. The system 10 of the present invention also permits the use of the existing GPS technology to transmit the location of an accident.

Referring to FIG. 8, the radar sensor 46 of the display units 12 on the intersections A, B, and C, measure the speed of vehicles approaching these intersections A, B, and C only for the duration of the green signal for each cycle of light. For example, intersection A is a half mile from point B, which in its turn is a half mile from point C. The radar signals are transmitted to the processor unit 22 that calculates the average speed of the traffic flow during the green signal for the location of the display unit that is designated by the Global Positioning System 20 at intersection A. The timing of the measurements have a delay of 1 to 5 seconds, or more, to allow the traffic to start moving after the red light is ON. Alternatively, the speed may be measured for the 5 seconds, or more, prior to the change of light from green to yellow. This process is simultaneously analyzed for the intersections B and C, with the corresponding GPS location on the map.

Based on the information provided by the GPS, the processor unit 22 calculates the distance between display unit 12 at A, B, and C intersections during the green light cycle. The information about average speeds per distance at points A to B, and B to C, is then transmitted by the processor unit 22 to the display unit 12 at point A assuming that the flow of traffic is directed from points A to B and B to C.

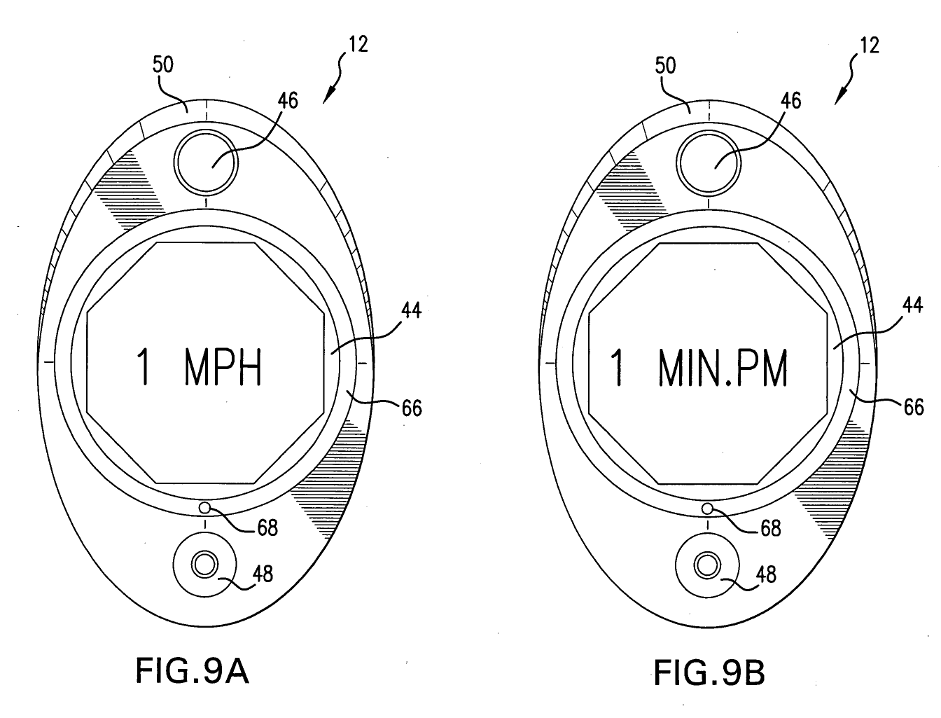

This information is then displayed on a steady red light display 12 or alternatively on portable traffic display systems 36 which may be placed at designated locations on the road. The message on the display unit 12 at the intersection A may be presented in two forms shown in FIGS. 9A and 9B.

For example, as shown in FIG. 9A, a message on the “STOP” red signal display in location A is presented indicating that the speed is 1 mile per hour for the next mile (which is the distance between points A and C). Alternatively, the speed can be presented as for the distance of half a mile which is the distance between locations A and B. The information shown preferably represents a deviation from the normal speeds for that location at the same time and the same calendar day of a year. Thus, if the speed of vehicle approaching intersection B is abnormally slow, e.g., for example, 1 mph, while the speed of vehicles approaching intersection C is near normal, then the message and traffic display A may show that traffic speed is 1 mph for the next half mile. If, for example, the average speed of vehicles approaching intersection B is near normal, but the speed of vehicles approaching intersection C is 1 mph, then the message on traffic display A may display the traffic speed as 1 mph, for half a mile ahead.

Alternatively, the message may be standardized giving reports of average vehicle speed in for example half a mile, or a mile, or other increments. An example of a standardized message would show that the traffic speed is 1 mph for the first half mile, 10 mph for the second half mile, and 50 mph for the third half mile, etc. Alternatively, the display of the steady red signal shows the time (minutes) per distance (miles) to be traveled, for instance, one minute, two minutes, or five minutes per mile of distance ahead, as shown in FIG. 9B.

Time per distance may be more appealing for commuters than miles per hour speed representation, since the former gives more useful information as to how long it will take to travel from point A to points B and C under current traffic conditions. Thus, the message may read five minutes per mile, or 5 min. p.m., as shown in FIG. 9B. Similar messages may be shown on left, right and slanted turn signals for the speed on the roads in the respective direction.

Similar but portable traffic displays 36, shown in FIG. 1, may be placed at important locations on a road or a highway to accommodate changing traffic patterns and inform drivers of the traffic conditions ahead. An algorithm presented in further paragraphs is used to assess the degree of deviation of the measured average speed compared to data stored in the computer regarding the traffic speeds normal for that location at the time and day of the week, or calendar year.

Referring now to FIG. 10, there is provided a flow chart diagram of the subsystem 28, shown in FIG. 1 and corresponding to the FIGS. 8 and 9A-9B, the system for measuring the traffic condition at intersections B and C and presenting this information at intersection A is initiated with the block 100 “Assign Intersections A, B, and C GPS Coordinates”.

In the algorithm of the software underlying the function of the system 10 of the present invention, the processor unit 22 acquires the coordinates of the display units 12 located respectively at the intersection A, B, and C, as shown in FIG. 8 through communication with the GPS 20. From block 100, the flow chart diagram of the subsystem 28 passes to block 110 “Calculate A-B, and B-C Distances”, where the processor 22 calculates the distances between the intersections based on the GPS coordinates of the display units 12 positioned at these geographical locations. Further, the logic flows to block 120 “Apply a Predetermined Time Delay to Switching Red to Green” where the processor unit 22 commands the sensors 46 in display units 12 positioned at intersections A, B, and C, to delay measuring the speed of the traffic flow for several seconds, after the red “STOP” signal is switched to the green “GO” signal in order to allow the traffic flow to start moving after the red light.

From block 120, information passes to block 130 “Measure Speed of Traffic at A, B, and C Intersections”, where the processor unit 22 commands the sensors 46 of the display unit to transmit a signal 2A (shown in FIG. 2) to approaching traffic and receives the return signal 2B there from. Based on the time of the speed of the signal to vehicles and back to the sensor the processor unit 22 calculates the speed of the traffic flow.

The speed of the traffic flow is measured continuously. However, when there are no vehicles on the road, the sensors do not record speed. The speed is recorded only when vehicles are within the radar's range. As a vehicle enters the radar's range, the speed thereof will be continuously recorded and data will be sent to the CPU. From the block 130, the algorithm of the subsystem 28 provides information flow to block 140 “Calculate Average Traffic Speed Between Points A, B, and B, C” where the processor unit 22, based on the coordinates of the points A, B, and C assigned by the GPS 20 and based on the measured speed of the traffic flow at the locations A, B, and C, calculates the average speed of the vehicles traveling between points A, B, and C during the green light cycle. The system assumes a minimum number of vehicles (0-2, or 3 or more) in order to calculate average speed.

From block 140, information flows to block 150 where the processor unit 22 transmits calculated average speeds of the vehicles traveling between points A, B, and C to the display unit 12 positioned at A intersection. The message corresponding to the information about the traffic flow in front of the intersection A may be shown on a steady red signal of the display unit 12 or alternatively on a portable traffic display 36. The presentation of the method regarding the traffic flow condition in front of the intersection A is shown in FIGS. 9A and 9B and described supra in association with these Figures. The information may be presented either as a speed of the traffic flow ahead for certain distance increments, or as time to travel per predetermined distance increments. The information also may be presented as a deviation of the measured average speed compared to the speed normal for the location at that time and calendar date.

In order to present the degree of deviation of the measured average speed, the logic flows from block 150 to block 160 “Calculate Deviation of Speed from Normal” where the measured and calculated average speeds are compared to data stored in the memory block 34 regarding the normal average speeds of the traffic flow for these locations. The information on the deviation of the current traffic flow condition from the norm is presented further either as a speed at predetermined distance increments or time to travel predetermined increments of distance and displayed at the display unit 12 located at the intersection A. Logic flows to block 170 where the processor unit 22 sends signals corresponding to the data to be displayed either in the form shown in FIG. 9A, or FIG. 9B.

In an alternative form of the flow chart diagram of the software underlying the function of the subsystem 28 of the processor unit 22, in block 120 instead of applying a predetermined delay after switching of the red signal to the green, the processor unit 22 may use the predetermined delay, before the change of light from green signal to yellow signal.

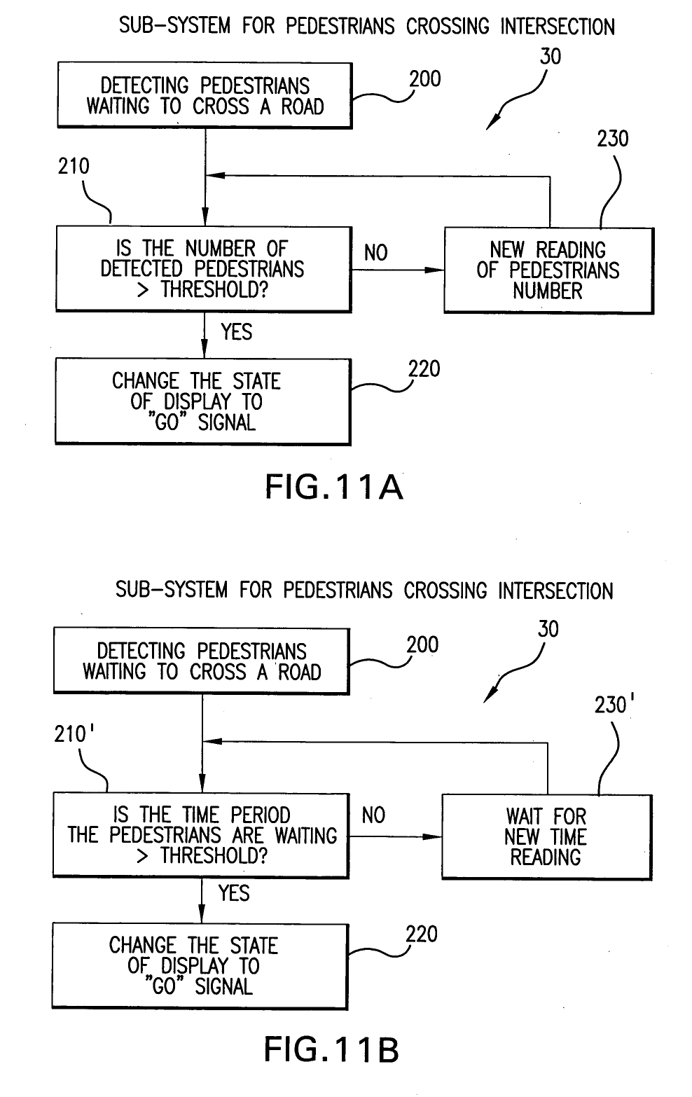

FIGS. 11A and 11B show the information flow for two alternative algorithms underlying the function of the subsystem 30 which is designed specifically as a portion of the system 10 of the present invention for controlling the display units 12 to detect the presence of the pedestrians waiting to cross the road and to facilitate the safe crossing of the road by the pedestrians by means of switching the signal light once the safe crossing condition is present. The algorithm underlies the function of the subsystem 31, shown in FIG. 1. The flow chart of the subsystem 30 is initiated in block 200 “Detection of Pedestrians Who Are Waiting to Cross the Intersection”, where the sensors 46 within the display unit 12 detect pedestrians who are about to cross the intersection. The logic flows from the block 200 to block 210 “Is the Number of Detected Pedestrians Larger than a Predetermined Threshold Number?” where the processor unit 22 compares the number of waiting pedestrians to a predetermined threshold. If the number of pedestrians exceeds a predetermined threshold number, the logic flows to block 220 “Change the State of the Display” where the processor unit 22 issues a signal to the display unit 12 to change the current signal at the display unit 12 to the “GO” signal shown in FIG. 7A. This permits the pedestrians waiting at the intersection to be signaled to cross the road. If however, the number of the pedestrians at the intersection is below the predetermined threshold, the logic flows to block 230 “Wait for New Reading of the Number of Pedestrians” and loops back to the logic block 210.

Presented in FIG. 1B is an alternative algorithm of the subsystem 30 where instead of the block 210, the logic uses the block 210 to compare the time periods the pedestrians wait at the intersection with a predetermined time threshold. Particularly, if the time period of the waiting pedestrian exceeds the predetermined threshold, then the logic flows to block 220. “Change The State of Display to “GO” signal” to cross the road. If, however, the waiting time is below the predetermined threshold, the logic flows to block 230′ “Wait for New Time Reading” and loops back to block 210′. In order to assist blind pedestrians, sound may be used to identify “GO” signal, “STOP” signal, as well as the time remaining until a signal's change.

It is clear that the same algorithm presented in FIGS. 11A and 11B for the subsystem 30 may be used for subsystem 31 for traffic flow vehicles.

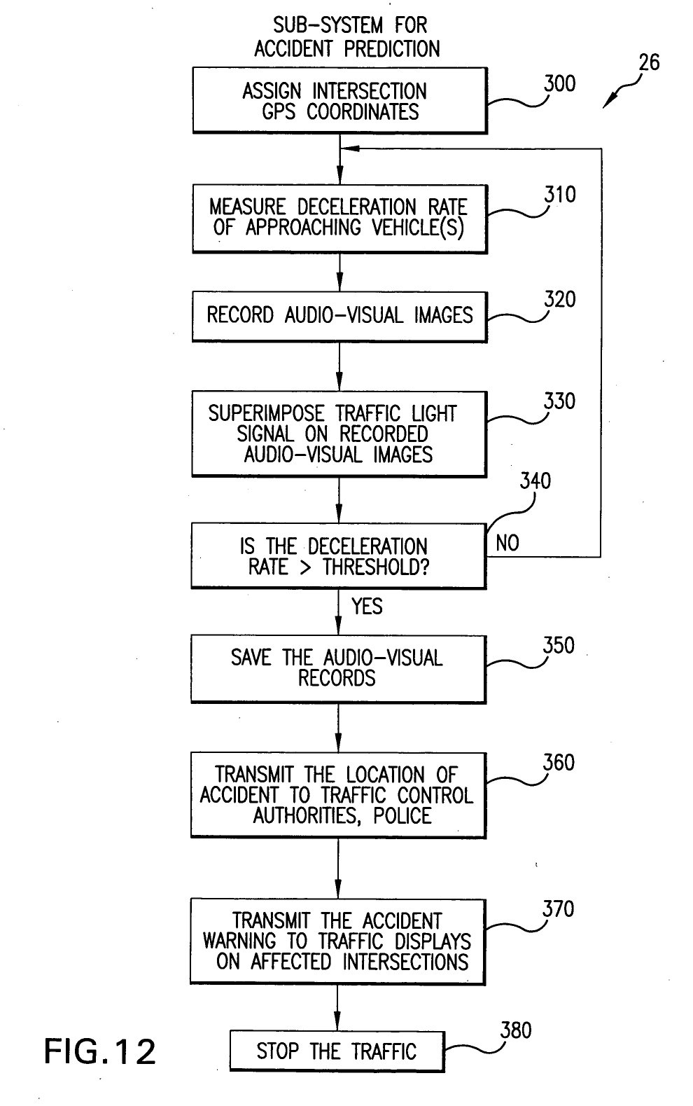

Referring to FIG. 12 representing a flow chart diagram of the algorithm underlying the operation of subsystem 26 shown in FIG. 1, for prediction of accidents, the operation of the subsystem 26 begins in block 300 “Assign Intersection GPS Coordinates” where the processor unit 22 acquires the coordinates from the GPS 20 for the position of display units. Further, the logic flows to block 310 “Measure Deceleration of Approaching Vehicle(s)” where sensors 46 within the display unit's 12 compartment send continuous signals 2A to the traffic flow and receive continuous responses 2B from the approaching vehicles as shown in FIG. 2.

The sensors 46 of the display unit 12 preferably are a radar-based system which comprises an antenna assembly, a signal processing unit, and an output monitor. The radar signal 2A generated and transmitted by the antenna assembly travels to the vehicle within the traffic flow and is reflected back. The reflected signal 2B returns to the sensor 46 which includes a receiver to receive the return signal. The transceiver of the sensor 46 processes the return signal to determine the distance of the approaching vehicle traveled during the time elapsed between the signal transmission by the radar antenna and the receipt of the return signal by the transceiver of the sensor 46.

Based on the elapsed time of the series of radar signals generated at certain intervals, the deceleration rate of the approaching vehicle is calculated. Specialized sensors differentiate objects by the intensity of the return radar signal are located at different locations of intersections or roads, particularly those with high likelihood of accidents.

These sensors may utilize lasers, radar, or other technique for sensing vehicles and other objects in the field of view of the sensors. These sensors detect velocity, direction, size, and shape of objects approaching or leaving the area being monitored. The sensors are connected to rapid sequence cameras or other audio visual recording devices 48 in the display unit 12 either by means of hard wiring or by means of wireless communication techniques. An accident in the system of the present invention is predicted by the rate of deceleration of the vehicles or other objects approaching the sensor(s).

From block 310, the flow chart flows to block 320 “Record Audio Visual Images at the Intersection” where the rapid sequence film cameras or other imaging sensors with night vision and flash illuminating capabilities are used to document the events at the intersection or road of interest. The logic further flows from block 320 to block 330 “Superimpose Traffic Light Signal” on recorded audio-visual images where the color of the traffic light signal is recorded and superimposed on the recorded audio visual images taken in block 320. The logic further flows to block 340 “Is the Deceleration Rate Higher than the Threshold?” If “NO”, the logic loops back to the record audio visual images for further continuous recording of the intersection or road of interest. If however, the deceleration rate of the approaching vehicle exceeds the predetermined threshold, the flow passes to the logic block 350 “Save the Audio Visual Images” where the processor unit, based on comparison of the measured deceleration rate with the threshold, issues a signal to the cameras 48 to save the recorded audio visual images along with the superimposed traffic light signals in memory medium 34 such as video disk, etc.

In addition to the deceleration, other criteria may be used for prediction of an accident. It may include the detection of vehicle(s) with zero speed during the “GO” light cycle after a predetermined delay time has elapsed, or the detection of pedestrian(s) and vehicle(s) at the same location within the sensor's range, etc.

The saving of the recorded audio visual images will begin a few seconds before the time of the actuation of the save mode of the camera operation to allow recording of the events just prior to the accident. Reflecting mirrors located inside of the hood 50 of the housing 40 of the display unit 12 reflect the color of the light display on the camera which in turn superimposes the color of the display on the image of the road and vehicles in block 330.

The recorded audio visual film is stored either on site of the accident in the memory block 34, or is transmitted to an offsite location to be stored for future review and analysis. The logic further flows from block 350 to block 360 “Transmitting the Location of Accident to Traffic Control Authorities”. When the saving regime of the camera's operation is activated, signals are also transmitted to various locations 23 such as for example police departments or traffic control bureaus. In addition, when the cameras are activated for saving the recorded audio visual images, the lights at the intersection which are affected by the accident may be changed to the stop signal in order to disable the traffic until the arrival of police.

Additionally, the information about the accident may be transmitted to display units on roads leading to the accident site to warn vehicle occupants and the pedestrians of an ongoing accident condition. Information passes from block 360 to block 370 “Transmit the Accident Warning to the Traffic Displays on Intersections Which May be Affected” and further, the logic may flow to the block 380 “Stop the Traffic”. When information is presented at the display unit 12 relevant to the accident ahead, the vehicle occupants thus informed may seek alternative routes to avoid the accident site.

Cameras may also be triggered to save the recorded audio visual images by detecting unusual movement of the vehicles such as vehicle rotation, unexpected side motions, or vehicle turnovers.

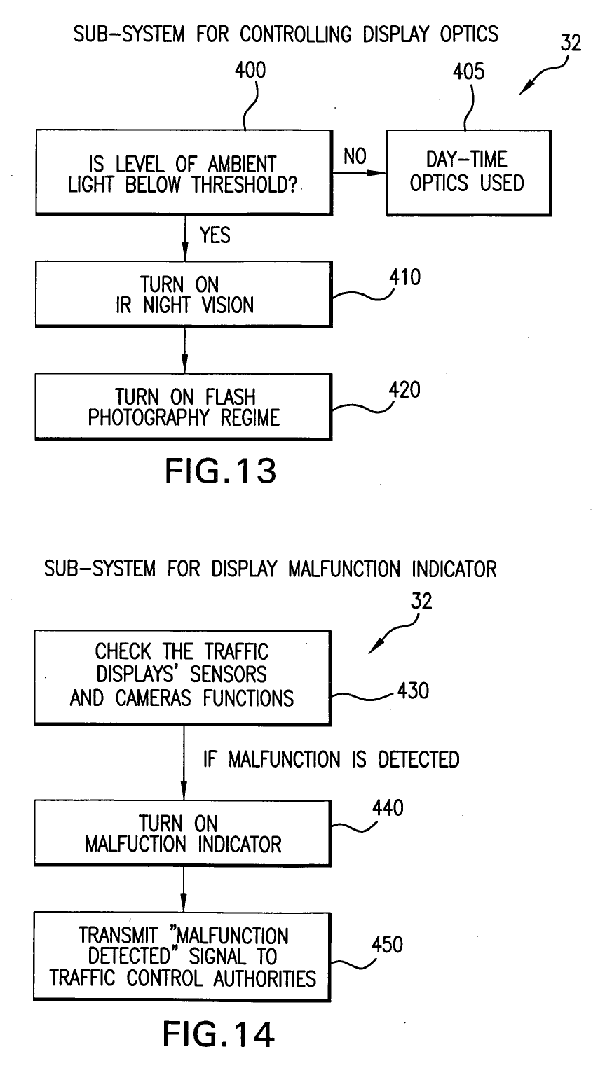

Referring to FIG. 13, the system 10 of the present invention, specifically the subsystem 32 for controlling functioning of the display units also includes the feature of changing the regime of the display unit operation based on the ambient light intensity. This flow chart starts in block 400 where the processor unit 22 compares the level of ambient light with a predetermined threshold. If the level of the ambient light is below the predetermined threshold, the logic flows to block 410 “Turn On IR Night Vision” and further to block 420 “Turn On Flash Photography Regime”. If however the level of the ambient light exceeds the predetermined threshold, the display unit continues to use the standard daytime optics.

Subsystem 32 for controlling function of the display unit 12 further includes a provision for system malfunctions. This provision presented as a flow chart in FIG. 14, is initiated at block 430 “Check the Traffic Display's Sensors and Camera's Functions” where the processor unit 22 monitors the function performance parameters of the subject display unit. If a malfunction is detected, the logic flows to block 440 “Turn On Malfunction Indicator” where the processor unit 22 issues a signal to the display unit 12 so that the corresponding message is displayed thereon. The logic further flows to block 450 “Transmit Signal to Authorities” where the processor unit 22 issues a signal indicative of the detected malfunction of specific display units 12 which is transmitted to predetermined sites.

The system for traffic surveillance, control, and traffic related information display is a multi-functional, effective, reliable system allowing conveyance to the vehicle occupants and pedestrians of simple, clear and universally understandable visual messages. The system is advantageous by the low energy consumption, convenience and low maintenance requirements. The system provides for easily recognizable messages to the pedestrians as well as vehicle occupants, thus enhancing the safety on the roads and streets. It is one of the great advantages of the system of the present invention that it predicts accidents as well as informing the vehicle occupants on the traffic conditions at the intersection and roads which may affect the traffic flow. The vehicle occupants fully furnished with the traffic flow conditions expected ahead on the trajectory of their travel have an opportunity to choose alternative roads.

Although this invention has been described in connection with specific forms and embodiments thereof, it will be appreciated that various modifications other than those discussed above may be resorted to without departing from the spirit or scope of the invention as defined in the appended Claims. For example, equivalent elements may be substituted for those specifically shown and described, certain features may be used independently of other features, and in certain cases, particular locations of elements may be reversed or interposed, all without departing from the spirit or scope of the invention as defined in the appended Claims.

What is claimed is:

1. A system for traffic related information display and traffic surveillance, comprising:
a plurality of display units, each of said display units positioned at a respective one of a plurality of predetermined locations associated with traffic flow,
each of said plurality of display unit including at least one sensor continuously monitoring the traffic flow and at least one camera continuously recording audio-visual rapid sequence images of the traffic flow at said respective predetermined location, said each display unit having a “STOP” state, “GO” state, and “WAIT” state; and
a processing unit coupled to said plurality of the display units, said processor unit including a first unit for predicting accidents based on deceleration rates of vehicles approaching said respective predetermined location.

2. The system of claim 1, wherein said processor unit initiates storing of the audio-visual rapid sequence images obtained from one or more cameras surrounding the location in a memory unit when said deceleration rate exceeds a predetermined threshold.

3. The system of claim 1, wherein said at least one sensor is a speed sensor measuring speed of vehicles approaching said respective predetermined location,
said processor unit for processing the measured speed and initiating storage of the audio-visual rapid sequence images in a memory unit when said measured speed exceeds a predetermined speed threshold.

4. The system of claim 1, wherein said at least one sensor is a speed sensor measuring speed of vehicles approaching said respective predetermined location,
said processor unit for processing the measured speed and initiating storage of the audio-visual rapid sequence images in a memory unit when said measured speed is zero and a predetermined time has elapsed after the onset of a “GO” signal.

5. The system of claim 1, wherein said at least one sensor detects vehicles in said respective predetermined location,
said processor unit for processing vehicle location and initiating storage of the audio-visual rapid sequence images in a memory unit when said sensors detect at least one vehicle which has not cleared said location and a predetermined time has elapsed after the transition to said “STOP” state of said display unit, and
said processor unit for initiating a delay in the activation of the traffic light sequence to allow said at least one vehicle to clear said location prior to initiating of said “GO” state of said display unit for vehicles at a crossing road, and for triggering the cameras to store and to record violations caused by said at least one vehicle.

6. The system of claim 1, wherein said processor unit further comprises:
a second unit for generating data indicative of traffic conditions at predetermined locations other than said respective predetermined location, a message corresponding to said data being displayed at said each display unit positioned at said respective predetermined location.

7. The system of claim 1, further comprising:
a third unit for detecting presence of pedestrians waiting to cross a road at said respective predetermined location, said third unit generating a control signal to switch said each display unit to said “GO” state when the number of the detected pedestrians exceeds a predetermined threshold number and/or if a waiting time period of said detected pedestrians exceeds a predetermined time threshold.

8. The system of claim 1, further comprising:
a third unit for detecting pedestrians crossing a road and for detecting pedestrians who have not cleared the road by the transition of said display unit to said “STOP” state, said processor unit delaying the activation of the “GO” state of said display unit for vehicles until the detected pedestrians finish to cross the road.

9. The system of claim 1, wherein each of said predetermined locations is assigned respective coordinates by a Global Positioning System (GPS).

10. The system of claim 1, wherein said each display unit includes:
a single compartment housing having a substantially oval shape,
a plurality of said sensors mounted in said compartment housing,
a plurality of said cameras, and
a plurality of light elements, said “STOP” state, “GO” state and “WAIT” state of said display unit being indicated in a color display area by red, green, and yellow colors generated by said plurality of light elements.

11. The system of claim 10, further comprising a time indicator showing a time period remaining until a change of the state of said display unit occurs,
said time indicator including an annularly shaped area surrounding said color display and a displaceable indicia moving along said annularly shaped area.

12. The system of claim 11, wherein said movable indicia is displaced in a first direction to indicate the remaining time in seconds if said remaining time is below 60 seconds, and in a second direction to indicate the remaining time in minutes if the remaining time exceeds 60 seconds.

13. The system of claim 1, wherein said “GO” state of said each display unit is indicated in the form of a revolving green tire-shaped figure.

14. The system of claim 13, wherein a speed of revolution of said green tire-shaped figure is responsive to a speed limit at said respective predetermined location.

15. The system of claim 10, wherein said “STOP” state of said each display unit is indicated by an octagonal shaped figure of red color displayed in said color display area.

16. The system of claim 10, wherein said “WAIT” state of said each display unit is indicated by a triangularly shaped figure of yellow color displayed in said color display area.

17. The system of claim 10, wherein said sensors include radar and/or lasers.

18. The system of claim 10, wherein said cameras of said each display unit record the state of said each display unit as indicated in said color display area thereof, and wherein said processor unit superimposes said recorded state on said recorded audio-visual rapid sequence images corresponding thereto.

19. The system of claim 10, wherein said housing includes a hood and a plurality of light reflectors secured to said hood.

20. The system of claim 10, wherein said each display unit includes a direction indicia displayed thereon.

21. The system of claim 1, further comprising indicia representing information messages corresponding to output signals generated by said processor unit upon analyzing of the readings of said at least one sensor and the audio-visual records of said at least one image sensing device.

22. The system of claim 1, further comprising a plurality of portable display units communicating with said processor unit.

23. A method for traffic surveillance, control and traffic related information display, the method comprising the steps of:
positioning a plurality of electronic display units at predetermined locations along a traffic trajectory;
connecting said plurality of electronic display units to a processor unit for analyzing thereat data transmitted from said plurality of electronic display units;
receiving there from signals corresponding to information to be displayed on said electronic display units;
providing each of said plurality of electronic display units with a plurality of sensors, a plurality of image sensing devices, a plurality of light emitting elements, and a color display area, said color display area indicating “GO”, “STOP”, and “WAIT” states of said each electronic display unit;
continuously monitoring traffic flow by said plurality of sensors;
continuously recording audio-visual rapid sequence images of the traffic flow by said plurality of image sensing devices;
calculating, at said processor unit, a deceleration rate of vehicles approaching said predetermined locations;
storing the images recorded by the image sensing device when the calculated deceleration rate exceeds a predetermined threshold; and
displaying the accident alert message at respective ones of said plurality of display units positioned at respective predetermined locations.

24. The method of claim 23, further comprising the steps of:
detecting by said sensors of said each display unit pedestrians waiting to cross a road,
switching said color display area to indicate thereat the “GO” state once the detected number of the waiting pedestrians exceeds a predetermined threshold number and/or the waiting time of the detected at least one pedestrian exceeds a predetermined time threshold,
detecting by said sensors of said each display unit pedestrians who have not cleared the road when the “STOP” state is indicated at the display unit,
said sensors sending signals to said processor unit to cause delay of the “GO” state for vehicles.

25. The method of claim 23, further comprising the steps of:
positioning a time indicator on said each display unit, said time indicator including an annularly shaped ring surrounding said color display area, and an indicia moving along said ring,
revolving said indicia in clockwise direction if the time remaining to the change of the state of said each display unit is below 60 seconds, and
revolving said indicia in counter-clockwise direction if time remaining to the change of the state of said each display unit exceeds 60 seconds.

26. The method of claim 23, further comprising the steps of:
displaying on said each display unit an information message from the group of messages consisting of color and specific indicia indicative of the “GO”, “STOP”, or “WAIT” state, speed limit, speed of the traffic flow at predetermined road portions, accident alert, direction arrows, time of the day, and weather information.

27. The method of claim 23, further comprising the steps of:
measuring the speed of the traffic flow, and
saving the images recorded by the image sensing device when the measured speed exceeds a predetermined traffic speed threshold.

28. The method of claim 23, further comprising the steps of:
measuring the speed of the traffic flow, and
saving the images recorded by the image sensing device when the measured speed is zero and a predetermined time threshold has elapsed after the initiation of the “GO” state.

29. The method of claim 23, further comprising the steps of:
detecting the location of vehicles in the traffic flow, and
saving the images recorded by the image sensing device when vehicles are detected at said predetermined location and a predetermined time has elapsed after the initiation of the “STOP” state.

30. The method of claim 23, further comprising the step of:
transmitting accident alert information to predetermined authorities.
